(19) United States
(12) Patent Application Publication
(10) Pub. No.: US 2010/0150612 A1
(43) Pub. Date: Jun. 17, 2010

(54) OSCILLATOR DEVICE AND METHOD OF MANUFACTURING THE SAME

(75) Inventors: Kazutoshi Torashima, Yokohama-shi (JP); Takahisa Kato, Tokyo (JP)

Correspondence Address: FITZPATRICK CELLA HARPER & SCINTO, 1290 Avenue of the Americas, NEW YORK, NY, 10104-3800, US

(73) Assignee: CANON KABUSHIKI KAISHA, Tokyo (JP)

(21) Appl. No.: 12/600,836

(22) PCT Filed: Jun. 30, 2008
(86) PCT No.: PCT/JP2008/062241

§ 371 Date: Nov. 18, 2009

(30) Foreign Application Priority Data
Jun. 29, 2007 (JP) 2007-172732

(51) Int. Cl. G03G 15/04; G02B 26/10; F16H 21/44; B23P 11/00

(52) U.S. Cl. 399/221; 359/221.2; 74/96; 29/428; 29/896.9

(57) ABSTRACT

An oscillator device includes a supporting member, a movable member, an elastic supporting member configured to elastically support the supporting member and the movable member around an oscillation axis, and a driving member configured to drive the movable member, wherein the elastic supporting member includes a plurality of springs and at least one spring constant adjusting member configured to couple the plurality of springs with each other.

### TECHNICAL FIELD

This invention relates to an optical deflector, an image forming apparatus using the same, and an optical equipment such as a display unit. For example, this optical deflector can preferably be used in a projection display for projecting an image by scanningly deflecting a light or an image forming apparatus such as a laser beam printer, a digital copying machine or the like having an electrophotographic process.

### BACKGROUND ART

Conventionally, various proposals have been made in regard to an optical scanning system or an optical scanning device as an optical deflector wherein a movable member having a reflection surface is sinusoidally oscillated to deflect light. Here, an optical scanning system using an optical deflector which sinusoidally oscillates based on resonance phenomenon has the following advantageous features as compared with an optical scanning optical system using a rotary polygonal mirror such as a polygon mirror. That is: the size of the optical deflector can be reduced significantly; the power consumption is small; an optical deflector made of Si monocrystal and produced by a semiconductor process has theoretically no metal fatigue and the durability is very good; and so on.

As an example of optical deflector, there is an optical scanner device such as shown in FIG. 8 and FIG. 9 (see WO2005026817). The structure 1 constituting an optical scanner device shown in FIG. 8 comprises a planar fixed member 2, a movable member 4 and a torsion beam 3 for connecting the fixed member 2 and the movable element 4. These elements are made by a semiconductor photolithography technique, with good precision. Furthermore, there is a mirror 5 formed on the surface of the movable member 4.

Furthermore, as shown in FIG. 9, this optical scanner device comprises a hard magnetic material (film magnet) 6 which is provided on one surface of the movable member 4. Furthermore, an electromagnet 20 which comprises a core 7 and an electric coil 8 is disposed at a position providing a magnetic action in corporation with this hard magnetic material 6. Based on a magnetic field produced in response to flow of a driving current to the electric coil 8 of the electromagnet 20 as well as an attractive force and a repulsive force generated by the magnetic field of the hard magnetic material 6, the movable member 4 is torsionally oscillated around a rotational axis.

### DISCLOSURE OF THE INVENTION

The resonance frequency of the movable member 4 of the optical scanner device (optical deflecting device) described above is determined by the spring constant of the torsion beam 3 and the inertia moment of the movable member 4. Since this resonance frequency is different with the use of the optical deflecting device, optical deflecting devices having resonance frequencies appropriate to the individual uses must be produced. For example, in the electrophotographic process as of laser beam printers, since the printing speed depends on the driving frequency of the optical deflecting device, it is necessary to change the resonance frequency of the optical deflecting device in accordance with the performance of each laser beam printer.

However, in order to separately produce optical deflecting devices having different resonance frequencies, it is necessary to change the production method and this leads to an increased manufacturing cost. This problem similarly applies to the oscillator device constituting an optical deflecting device.

The present invention provides an oscillator device by which the resonance frequency can be changed in a wide area, as well as a method of manufacturing such oscillator device.

In accordance with an aspect of the present invention, there is provided an oscillator device, comprising: a supporting member; a movable member; an elastic supporting member configured to elastically support said supporting member and said movable member around an oscillation axis; and a driving member configured to drive said movable member; wherein said elastic supporting member includes a plurality of springs and at least one spring constant adjusting member configured to couple the plurality of springs with each other.

In accordance with another aspect of the present invention, there is provided an oscillator device, comprising: a supporting member; a movable member; an elastic supporting member configured to elastically support said supporting member and said movable member around an oscillation axis; and a driving member configured to drive said movable member; wherein said elastic supporting member includes constituent members configured to constitute a meandering structure and at least one spring constant adjusting member configured to couple said constituent members with each other.

In one preferred form of these aspects of the present invention, said supporting member, said movable member, said elastic supporting member and said spring constant adjusting member are formed integrally from monocrystal silicon.

In accordance with a further aspect of the present invention, there is provided an optical deflector, comprising: an oscillator device as recited above; and an optical deflecting element provided at said movable member of said oscillator device.

In accordance with a still further aspect of the present invention, there is provided an image forming apparatus, comprising: a light source; an optical deflector as recited above; and a photosensitive member; wherein a light beam from said light source is deflected by said optical deflector to form an electrostatic latent image on said photosensitive member.

In accordance with a yet further aspect of the present invention, there is provided a method of manufacturing an oscillator device having a supporting member, a movable member, an elastic supporting member configured to elastically support the supporting member and the movable member around an oscillation axis, and a driving member configured to drive the movable member, said method comprising: a step of forming an elastic supporting member having a plurality of springs and at least one spring constant adjusting member configured to couple the plurality of springs with each other; and a step of cutting the at least one spring constant adjusting member to change a spring constant.

In accordance with a still further aspect of the present invention, there is provided a method of manufacturing an oscillator device having a supporting member, a movable member, an elastic supporting member configured to elastically support the supporting member and the movable member around an oscillation axis, and a driving member configured to drive the movable member, said method comprising: a step of forming an elastic supporting member having a plurality of constituent members configured to constitute a meandering structure and at least one spring constant adjusting member configured to couple the constituent members with each other; and a step of cutting the at least one spring constant adjusting member to change a spring constant.

In accordance with a still further aspect of the present invention, there is provided a method of manufacturing an oscillator device having a supporting member, a movable member, an elastic supporting member configured to elastically support the supporting member and the movable member around an oscillation axis, and a driving member configured to drive the movable member, said method comprising: a step of forming an elastic supporting member having a plurality of springs; and a step of providing at least one spring constant adjusting member configured to couple the plurality of springs with each other, to change a spring constant.

In accordance with a yet further aspect of the present invention, there is provided a method of manufacturing an oscillator device having a supporting member, a movable member, an elastic supporting member configured to elastically support the supporting member and the movable member around an oscillation axis, and a driving member configured to drive the movable member, said method comprising: a step of forming an elastic supporting member having a meandering structure; and a step of providing at least one spring constant adjusting member configured to couple a plurality of constituent members constituting the meandering structure, with each other, to change a spring constant.

These and other objects, features and advantages of the present invention will become more apparent upon a consideration of the following description of the preferred embodiments of the present invention taken in conjunction with the accompanying drawings.

### BRIEF DESCRIPTION OF THE DRAWINGS

FIG. 1A is a top plan view for explaining an oscillator device according to a first working example of the present invention.

FIG. 1B is a sectional view along a line A-B in FIG. 1A, for explaining an oscillator device of the first working example of the present invention.

FIG. 1C is a top view for explaining an oscillator device having a one-end supported structure of the present invention.

FIG. 2A is a top plan view for explaining an oscillator device in which a spring adjusting member is provided (at two places) on an elastic supporting member of a meandering structure.

FIG. 2B is a top plan view for explaining an oscillator device in which a spring adjusting member is provided (at one place) on an elastic supporting member of a meandering structure.

FIG. 3A is a top plan view for explaining a method of manufacturing an oscillator device, according to a third working example of the present invention, and it illustrates the oscillator device before a spring constant adjusting member is cut away.

FIG. 3B is a top view for explaining a method of manufacturing an oscillator device, according to the third working example of the present invention, and it illustrates the oscillator device after the spring constant adjusting member is cut away.

FIG. 4A to FIG. 4C are diagrams for explaining a method of manufacturing an oscillator device according to the third working example of the present invention.

FIG. 5A is a top plan view for explaining a method of manufacturing an oscillator device, according to a fourth working example of the present invention, and it illustrates the oscillator device before a spring constant adjusting member is provided.

FIG. 5B is a top view for explaining a method of manufacturing an oscillator device, according to the fourth working example of the present invention, and it illustrates the oscillator device after the spring constant adjusting member is provided.

FIG. 6A and FIG. 6B are diagrams for explaining a method of manufacturing an oscillator device according to the fourth working example of the present invention.

FIG. 7 is a diagram for explaining an image forming apparatus according to a fifth working example of the present invention.

FIG. 8A and FIG. 8B are diagrams illustrating a conventional optical deflector.

FIG. 9 is a diagram illustrating a conventional optical deflector.

### BEST MODE FOR PRACTICING THE INVENTION

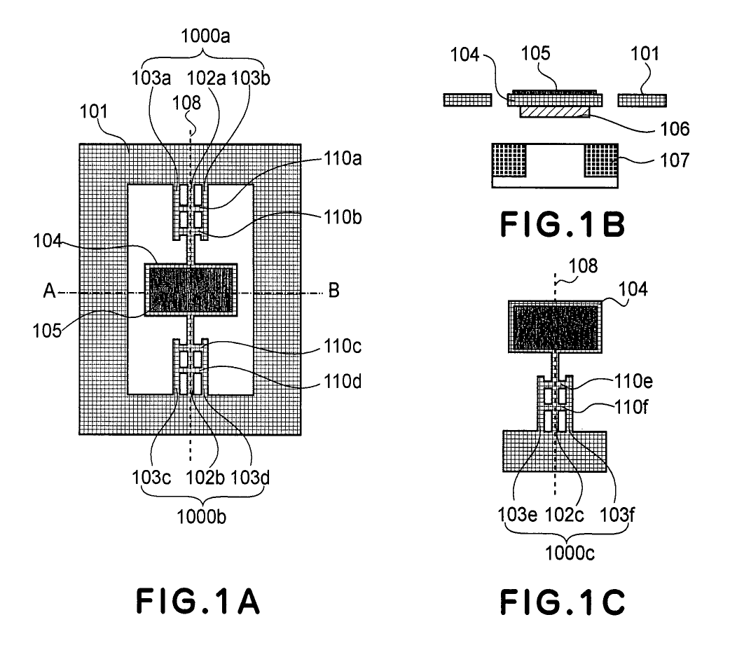

Referring first to FIGS. 1A-1C, one preferred embodiment of the present invention will be described.

FIG. 1A is a top plan view of an oscillator device according to the present invention, and FIG. 1B is a sectional view taken along a line A-B in FIG. 1A.

The oscillator device of the present invention is comprised of a supporting member 101, a movable member 104 and elastic supporting members 1000a and 1000b. The elastic supporting members 1000a and 1000b comprise a plurality of springs 102a, 102b, 103a, 103b, 103c and 103d. These spring elements 102a, 102b, 103a, 103b, 103c and 103d function to elastically connect the movable member 104 to the supporting member 101, for torsional oscillation about an oscillation axis 108. The spring 102a is coupled with the springs 103a and 103b through spring constant adjusting members 110a and 110b which are provided to enable adjustment of the spring constant. This is also the case with the springs 102b, 103c and 103d. When the oscillator device of the present invention is used as an optical deflector, a reflection surface 105 which is an optical deflecting element may be provided on the movable member 104.

Furthermore, the oscillator device comprises driving means for producing resonance drive of the movable member 4 and drive control means for controlling the driving means (not shown). The driving means, now shown, has a structure for providing a drive based on an electromagnetic system, electrostatic system or piezoelectric system. An example of the structure is shown in FIG. 1B, wherein the movable member 104 has a hard magnetic material 106, and it is magnetized in a direction perpendicular to the oscillation axis 108. The hard magnetic material can be formed by sputtering or adhesion.

A magnetic field is produced by applying an electric current to the electric coil 107, and a torque is applied to the movable member 104, whereby the oscillator device can be driven. If the electric current to be applied to the electric coil 107 is an alternating current, the oscillator device can be driven by torsional oscillation corresponding to the frequency of the alternating current. Furthermore, by applying an alternating current the same as the resonance frequency of the oscillator device of the present invention to the electric coil 107, torsional resonance oscillation can be produced with a low power consumption.

FIG. 1C illustrates an oscillator device of a structure (single-end supported structure) in which the elastic supporting member is provided at a single location. With the single-end supported structure as illustrated, in addition to the torsional oscillation around the torsional axis which is the oscillation axis 108, oscillation in a direction perpendicular to the surface of the movable member 104 or oscillation rotating around the oscillation axis 108 can be generated.

It should be noted that, although the following description will be given in regard to an embodiment in which the movable element is supported at its opposite sides by means of elastic supporting members, such structure will be similarly applicable also the case of FIG. 1C.

The elastic supporting member of the oscillator device of the present invention has a plurality of springs and at least one spring constant adjusting member for coupling theses springs with each other.

The springs 102a, 102b, 103a, 103b, 103c and 103d function to elastically connect the movable member 104 to the supporting member 101, for torsional oscillation about the oscillation axis 108. The spring 102a is coupled with the springs 103a and 103b in parallel to each other, through spring constant adjusting members 110a and 110b which are provided to enable adjustment of the spring constant. Here, the spring constant of the springs 102a and 102b is denoted by K1, while the spring constant of the springs 103a, 103b, 103c and 103d is denoted by K2. On one hand, the spring 102a is coupled with the springs 103a and 103b in parallel to each other, through the spring constant adjusting members 110a and 110b which are provided to enable adjustment of the spring constant. On the other hand, the spring 102b is coupled with the springs 103c and 103d in parallel to each other, through spring constant adjusting members 110c and 110d which are provided to enable adjustment of the spring constant. Thus, the spring constant K of the elastic supporting member of the oscillator device of the present invention can be presented by equation (1) below.

K=2*(K1+2*K2) (1)

If the springs 102a and 102b are not coupled with the springs 103a, 103b, 103c and 103d through the spring constant adjusting members 110a, 110b, 110c and 110d, the spring constant of the elastic supporting member is presented by equation (2) below.

K=2*K1 (2)

As described above, if a plurality of springs are coupled in parallel by means of a spring constant adjusting member, the spring constant K of the oscillator device can be enlarged. If the inertia moment of the movable member is denoted by I, the resonance frequency f can be presented by equation (3) below.

$$f = \frac{1}{2 π} \sqrt{\frac{K}{I}} \qquad ( 3 )$$

Thus, the spring constant K can be largely changed and, therefore, the resonance frequency of the oscillator device can be changed very easily. Furthermore, since the spring constant adjusting member for coupling plural springs will be deformed together with these springs during the torsional oscillation, the stress concentration at the coupling point between the spring and the spring constant adjusting member can be reduced.

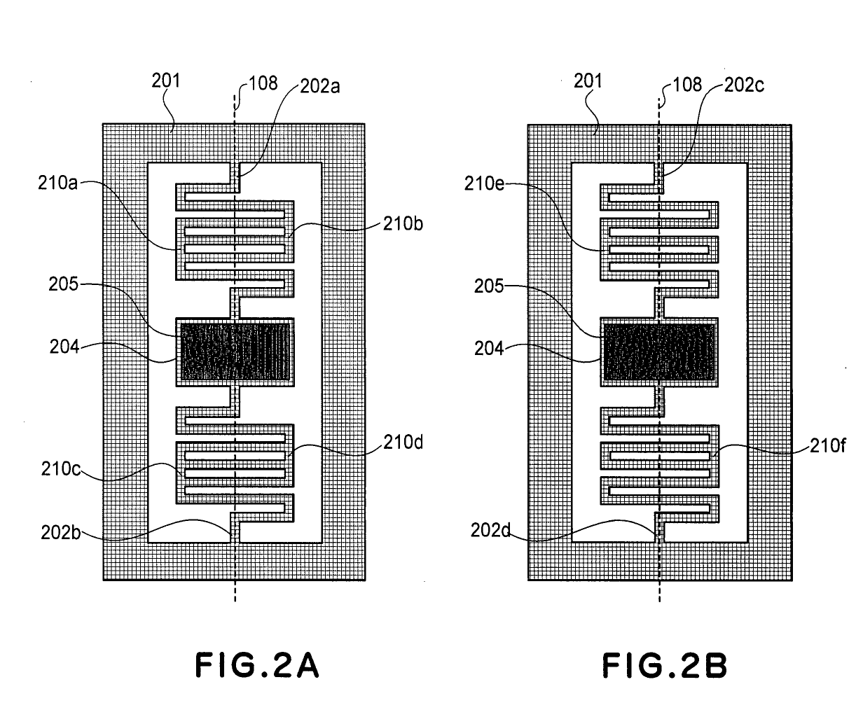

Furthermore, the oscillator device may have such structure that the elastic supporting member comprises members which provide a meandering structure and at least one spring constant adjusting member for coupling the meandering structure providing members with each other. FIG. 2A illustrates an example of oscillator device in which members for providing a meandering structure are coupled with each other at two locations by use of a spring constant adjusting member. As shown in FIG. 2A, if the elastic supporting member is cut along a section parallel to the oscillation axis 108, it has plural sections. The structure of the elastic supporting member having two or more sections parallel to the oscillation axis 108 is particularly called a meandering structure. This meandering structure may be a structure in which the elastic supporting member has two or more sections perpendicular to the oscillation axis 108.

In FIG. 2A, the members constituting the meandering structure are with each other through the spring constant adjusting members 210a, 210b, 210c and 210d. Namely, the elastic supporting members 202a and 202b of the respective meandering structures are coupled at two locations by use of the spring constant adjusting members.

Here, in FIG. 2A, it is assumed that the elastic supporting members 202a and 202b are not coupled by means of the spring constant adjusting members 210a, 210b, 210c and 210d. In that case, the spring constant of major spring elements constituting the elastic supporting members 202 and 202b, namely, of the portions perpendicular to the oscillation axis 108, is denoted by K1. Since the elastic supporting members 202a and 202b can be considered as coupling the respective spring components in series, the spring constant K of the elastic supporting members 202a and 202b is given by equation (4) below.

$$K = \frac{K 1}{5} \qquad ( 4 )$$

On the other hand, if the elastic supporting members 202a and 202b are coupled by means of the spring constant adjusting members 210a, 210b, 210c and 210d as shown in FIG. 2A, some springs can be considered as being coupled in parallel. Hence, the spring constant K can be expressed by equation (5) and equation (6) below.

$$\begin{matrix}\frac{1}{K} = \frac{2}{K 1} + \frac{1}{3 K 1} & ( 5 ) \\ K = \frac{3 K 1}{7} & ( 6 )\end{matrix}$$

Here, the first term of the right-hand side of equation (5) is the spring constant of a portion which is not coupled by the spring constant adjusting member. The second term is the spring constant of the portion coupled.

As described above, with the arrangement that the spring constant adjusting member couples the meandering structure at two or more, locations, the spring constant K of the oscillator device can be made larger. Thus, the resonance frequency of the oscillator device can be changed very easily. Moreover, with the use of a meandering structure, the overall length of the oscillator device can be shortened.

On the other hand, FIG. 2B shows an example wherein only a single spring constant adjusting member is used to couple the members constituting the meandering structure. In this case, some of the spring components constituting the meandering structure do not function as a spring. The meandering structure is couples the spring components in series. With the provision of spring components that do not function as a spring, the spring constant having a meandering structure can be made larger.

For example, the spring constant K of an elastic supporting member of meandering structure having five spring components (spring constant K1) can be presented by the following equation.

K=K1/5 (7)

On the other hand, as shown in FIG. 2B, the spring components of the elastic supporting members 202c and 202d are coupled with each other by means of spring constant adjusting members 210e and 210f, respectively. If two spring components are coupled with each other by use of a single spring constant adjusting member as described above, the spring constant will be as follows.

K=K1/3 (8)

Hence, with the provision of a spring component that does not function as a spring, the spring constant having a meandering structure can be made larger.

The oscillator device may have a structure that the supporting member, movable member, elastic supporting member and spring constant adjusting member are integrally formed from monocrystal silicon. With this arrangement, the oscillator device can be manufactured through a micromachining technique, at a very high finishing precision. Furthermore, the spring constant adjusting member can be made at very high positioning precision with respect to the elastic supporting member. Thus, an oscillator device having a desired resonance frequency can be provided with very high precision.

Furthermore, a structure having an oscillator device and an optical deflection device disposed above the movable member is possible in the present invention. With this structure, the optical deflector can be utilized in an oscillator device or the like.

Furthermore, an image forming apparatus having a light source, an optical deflector and a photosensitive member, wherein a light beam from the light source is deflected by the optical deflector and an electrostatic latent image is formed on the photosensitive member, is possible in the present invention. With this structure, various image forming apparatuses having different imaging forming speeds can be manufactured.

Next, a method of manufacturing an oscillator device having a supporting member, a movable member, an elastic supporting member for elastically coupling the supporting member and the movable member around an oscillation axis, and driving means for driving the movable member, will be described.

The manufacturing method in an aspect of the present invention is characterized by including a step of forming an elastic supporting member having a plurality of springs and at least one spring constant adjusting member for coupling the springs with each other, and a step of cutting the spring constant adjusting member to change the spring constant.

With the provision of these steps, oscillator devices having largely different resonance frequencies can be made through the same production method. For example, if the devices are made by using a micromachining technique, the same photomask may be used and then the point to be cut in the present step may be changed. Only by this change, oscillator devices having various resonance frequencies can be manufactured without changing the condition of other steps. Thus, the manufacturing cost can be reduced.

Another manufacturing method of the present invention may comprise the following step: that is, a step of forming an elastic supporting member having constituent members for constituting a meandering structure and at least one spring constant adjusting member for coupling the constituent members with each other, and a step of cutting the spring constant adjusting member to change the spring constant.

With the provision of these steps, oscillation devices of small overall length having greatly different resonance frequencies can be manufactured through the same production method. For example, if the devices are made by using a micromachining technique, the same photomask may be used and then the point to be cut in the present step may be changed. Only by this change, oscillator devices having short overall length and having various resonance frequencies can be manufactured without changing the condition of other steps. Thus, the manufacturing cost can be reduced.

Furthermore, a further manufacturing method of the present invention may include a step of forming an elastic supporting member having a plurality of springs, a step of providing at least one spring constant adjusting member for coupling the springs with each other to change the spring constant.

With the provision of these steps, oscillator devices having largely different resonance frequencies can be manufactured through the same production method. For example, if the devices are made by using a micromachining technique, the same photomask may be used and then the position where the spring constant adjusting member is going to be provided in the present step may be changed. Only by this change, oscillator devices having various resonance frequencies can be manufactured without changing the condition of other steps. Thus, the manufacturing cost can be reduced. Furthermore, since the position where the spring constant adjusting member should be provided can be chosen as desired, the smallest changing quantity of the resonance frequency of the oscillator device can be made smaller.

Furthermore, a further manufacturing method of the present invention may include a step of forming an elastic supporting member having meandering structures, and a step of providing at least one spring constant adjusting member for coupling the meandering structures with each other to change the spring constant.

With the provision of these steps, oscillator devices having largely different resonance frequencies and having a short overall length can be manufactured through the same production method. For example, if the devices are made by using a micromachining technique, the same photomask may be used and then the position where the spring constant adjusting member is going to be provided in the present step may be changed. Only by this change, oscillator devices having various resonance frequencies and having short overall length can be manufactured without changing the condition of other steps. Thus, the manufacturing cost can be reduced. Furthermore, since the position where the spring constant adjusting member should be provided can be chosen as desired, the smallest changing quantity of the resonance frequency of the oscillator device can be made smaller.

Now, the present invention will be explained in more detail with reference to some specific working examples thereof.

### Working Example 1

Referring to FIG. 1, the structure of an oscillator device of the first working example will be explained.

FIG. 1A is a top plan view of the oscillator device of the present invention, and FIG. 1B is a sectional view taken on a line A-B in FIG. 1A.

The oscillator device of the present invention comprises a supporting member 101, a movable member 104, and elastic supporting members 1000a and 1000b. The elastic supporting members 1000a and 1000b are comprised of springs 102a, 102b, 103a, 103b, 103c and 103d. These springs 102a, 102b, 103a, 103b, 103c and 103d function to elastically couple the movable member 104 with the supporting member 101 around the oscillation axis 108. The spring 102a is coupled with springs 103a and 103b through spring constant adjusting members 110a and 110b which function to change the spring constant. In the present embodiment, the number of the springs is six (6). However, the number of the springs should be just plural. If the number is made large, the variation of the resonance frequency can be made larger.

With regard to the size of the movable member 104, the length in the direction perpendicular to the oscillation axis is 1.3 mm, and the size in the direction parallel to it is 1.5 mm. The thickness is 0.2 mm. The full length of the chip is 15 mm. The supporting member 101, movable member 104, springs 102a, 102b, 103a, 103b, 103c and 103d, and spring constant adjusting members 110a and 110b are formed integrally from a monocrystal silicon substrate in accordance with photolithography and dry etching processes of the semiconductor production method. Thus, it can be made with very high finishing precision. Furthermore, since the spring constant adjusting member can be made at very high positioning accuracy with respect to the elastic supporting member, an oscillator device having desired resonance frequency can be accomplished with very high precision.

Since the oscillator device is provided with a reflection surface 105 which is an optical deflecting element disposed on the movable member 104, the oscillator device of the present invention can be used as an optical deflector. The material of the reflection surface 105 is aluminum, and it is formed by vacuum deposition. The reflection surface 105 may be made of another material such as gold or copper, for example. Furthermore, a protection film or dielectric multilayer may be formed thereon.

The driving principle of the present embodiment will be explained. The movable member 104 has a hard magnetic material 106 which is magnetized in a direction perpendicular to the oscillation axis. The electric current to be applied to the electric coil 107 is an alternating electric current. Thus, a magnetic field corresponding to the frequency of the alternating current is generated, and a torque is applied to the movable member 104, whereby the optical deflector is driven with torsional oscillation. Furthermore, if an alternating current the same as the resonance frequency of the optical deflector of the present invention is applied to the electric coil 108, torsional oscillation can be produced by low power consumption.

In the present embodiment, the spring constant of the springs 102a and 102b is 2*K1, and the spring constant of the springs 103a, 103b, 103c and 103d is K1. The spring 102a is coupled with the springs 103a and 103b through the spring constant adjusting members 110a and 110b which are provided to enable adjustment of the spring constant. Furthermore, the spring 102b is coupled with the springs 103c and 103d through the spring constant adjusting members 110c and 110d which are provided to enable adjustment of the spring constant. Therefore, from equation (1), the spring constant K of the oscillator device of the present invention can be presented by:

K=2*(2*K1+2*K1)=8K1

On the other hand, if the springs 102a and 102b are not coupled with the springs 103a, 103b, 103c and 103d through the spring constant adjusting members 110a, 110b, 110c and 110d, from equation (2), it follows that:

K=2*2*K1=4K1

Thus, when coupled with the spring constant adjusting members, the spring constant K of the oscillator device becomes twofold as compared with a case not coupled with the spring constant adjusting members. Then, from equation (3), the resonance frequency f can made about 1.4 times higher. Thus, with the structure of this working example, an oscillator device having a resonance frequency from 2000 Hz to 2800 Hz, for example, can be manufactured.

Since the spring constant K can be changed largely as described above, the resonance frequency of the oscillator device can be enlarged very easily. Furthermore, since the spring is coupled through the spring constant adjusting member, stress concentration can be reduced.

### Working Example 2

Referring to FIG. 2A, the structure of an optical deflector according to a second working example will be explained.

FIG. 2A is a top plan view of the oscillator device of the present invention. The structure of the oscillator device of the second working example is approximately the same as the oscillator device of the first working example. The feature of the optical deflector of this working example is that elastic supporting members 202a and 202b have a meandering structure, and that each of the elastic supporting member 202a and 202b having a meandering structure is coupled at two locations through spring constant adjusting members 210a, 210b, 210c and 210d.

With regard to the size of the movable member 204, the length in the direction perpendicular to the oscillation axis 108 is 1.3 mm, and the size in the direction parallel to it is 1.5 mm. The thickness is 0.2 mm. The full length of the chip is 7 mm.

It is assumed that the elastic supporting members 202a and 202b are not coupled by the spring constant adjusting members 210a, 210b, 210c and 210d. In that case, if the spring constant of portions of the elastic supporting members 202a and 202b which are perpendicular to the oscillation axis 108 is denoted by K1, the spring constant K of the elastic supporting members 202a and 202b can be presented by equation (4) mentioned hereinbefore.

On the other hand, if the elastic supporting members 202a and 202b are coupled with the spring constant adjusting members 210a, 210b, 210c and 210d as shown in FIG. 2A, the spring constant K can be presented by equations (5) and (6) mentioned hereinbefore.

Here, the first term at the right-hand side of equation (5) is the spring constant of a portion not coupled through the spring constant adjusting member, and the second term is the spring constant of the portion coupled.

Thus, when coupled with the spring constant adjusting members, the spring constant K of the oscillator device becomes approximately twofold as compared with a case not coupled with the spring constant adjusting members. Furthermore, from equation (3), the resonance frequency f can made about 1.4 times higher. Thus, with the structure of this working example, an oscillator device having a resonance frequency from 2000 Hz to 2800 Hz, for example, can be manufactured.

Since the spring constant K can be changed largely as in the first working example, the resonance frequency of the oscillator device can be enlarged very easily. Furthermore, with the use of a meandering structure, the total length of the oscillator device can be made short.

### Working Example 3

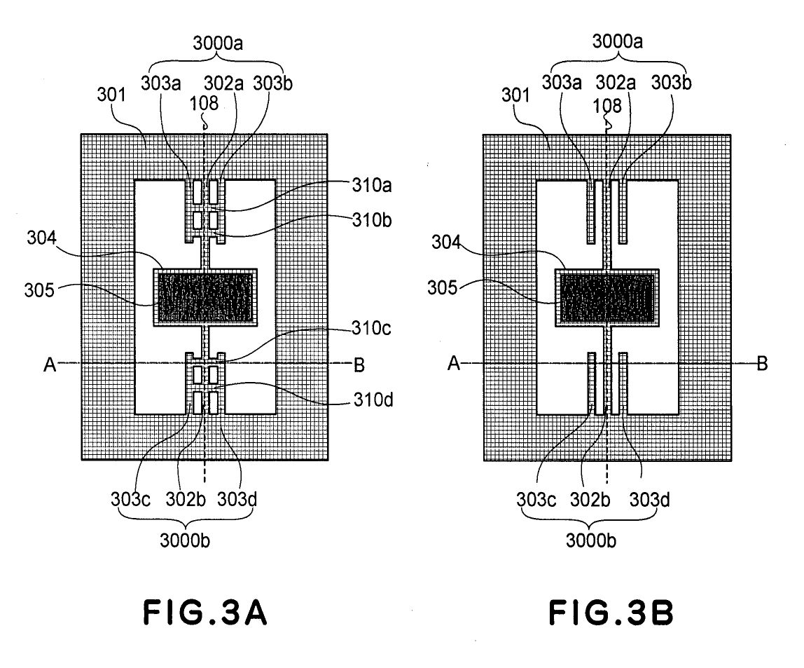

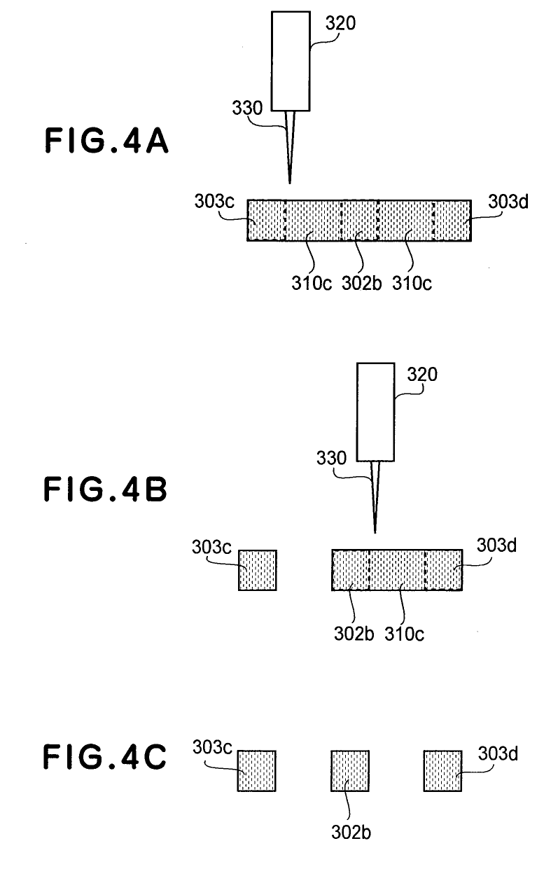

Referring to FIGS. 3 and 4, a method of manufacturing an oscillator device of the present invention, according to a third working example, will be explained.

FIG. 3A illustrates an oscillator device having completed the process before the step of cutting the spring constant adjusting members. FIG. 3B illustrates the oscillator device after the spring constant adjusting members are cut away. FIGS. 4A-4C are diagrams for explaining the process of cutting the spring constant adjusting members.

As shown in FIG. 3A, the oscillator device before its spring constant adjusting members are cut away comprises a supporting member 301, a movable member 304 and elastic supporting members 3000a and 3000b. The elastic supporting members 3000a and 3000b include springs 302a, 302b, 303a, 303b, 303c and 303d. These springs 302a, 302b, 303a, 303b, 303c and 303d function to elastically couple the movable member 304 with the supporting member 301 around an oscillation axis 108. The spring 302a is coupled with the springs 303a and 303b in parallel through spring constant adjusting members 310a and 310b which are provided to enable adjustment of the spring constant.

With regard to the size of the movable member 304, the length in the direction perpendicular to the oscillation axis is 1.0 mm, and the size in the direction parallel to it is 3.0 mm. The supporting member 301, movable member 304, springs 302a, 302b, 303a, 303b, 303c and 303d, and spring constant adjusting members 310a and 310b are formed integrally from a monocrystal silicon substrate in accordance with photolithography and dry etching processes of the semiconductor production method.

Since the oscillator device is provided with a reflection surface 305 which is an optical deflecting element disposed on the movable member 304, the oscillator device of the present invention can be used as an optical deflector. The material of the reflection surface 305 is aluminum, and it is formed by vacuum deposition. The resonance frequency here is about 2800 Hz.

The disconnection of the spring constant adjusting members is performed by laser beam machining. In the laser beam machining, a laser beam 330 emitted from a laser oscillation device 320 is collected to a small area to heat and melt or evaporate this portion. As shown in FIG. 4, the spring constant adjusting member 310c is cut away by the laser beam machining. Furthermore, the spring constant adjusting member 310d is cut away, to disconnect the spring 302b and the springs 303c and 303d. The cutting operation is carried out from an end portion to another end portion of the spring constant adjusting member. In the cutting operation, penetration from the top surface to the back surface may be repeated. Similarly, the spring constant adjusting members 310a and 310b are cut away by the laser beam machining, and the spring 302a and springs 303a and 303b are disconnected. Through this process, a resonance frequency of about 2100 Hz is obtainable. The number of cuttings of the spring constant adjusting members should be chosen in accordance with a desired resonance frequency. For example, if only the spring constant adjusting members 310b and 310c are cut, the resonance frequency will be about 2500 Hz. If, on the other hand, the spring constant adjusting members are not cut, the resonance frequency will be about 2800 Hz. Thus, with the provision of the process of cutting the spring constant adjusting members, oscillator devices having largely different resonance frequencies can be manufactured through the same production method. Thus, the manufacturing cost can be reduced significantly.

### Working Example 4

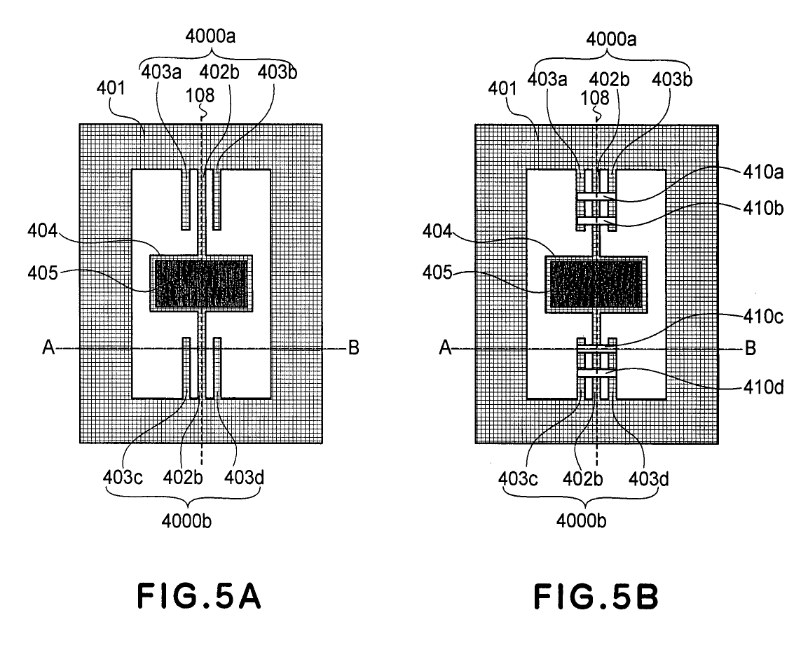

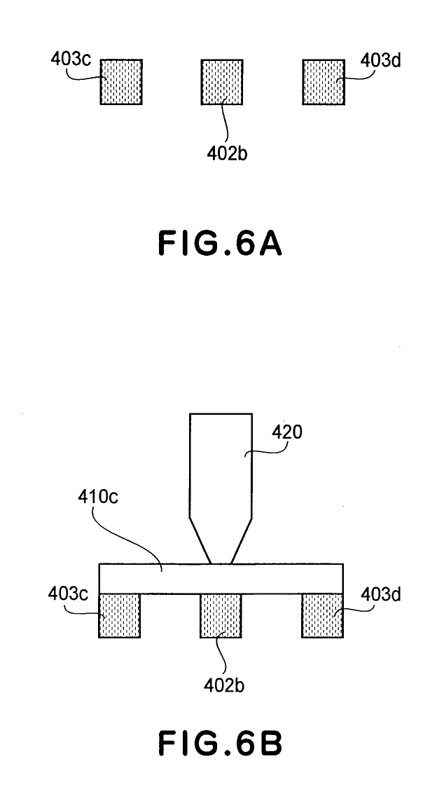

Referring to FIG. 5 and FIG. 6, a method of manufacturing an oscillator device of the present invention, according to a fourth working example, will be explained.

FIG. 5A illustrates an oscillator device before spring constant adjusting members are provided. FIG. 5B illustrates the oscillator device after the spring constant adjusting members are provided. FIGS. 6A and 6B diagrams for explaining the process of providing the spring constant adjusting members.

As shown in FIG. 5A, in the oscillator device of this working example, the spring 402a and the springs 403a and 403b are separated from each other. Similarly, the springs 402b, 403c and 403d are separated. In this case, the resonance frequency of the oscillator device shown in FIG. 5A is about 2140 Hz.

As shown in FIGS. 6A and 6B, a spring constant setting member 410c is mounted by use of a bonding machine 420 or the like to connect the springs 402b, 403c and 403d to each other. Similarly, spring constant adjusting members 410a, 410b and 410d are provided to connect the spring 402b with springs 403c and 403d and the spring 402a with springs 403a and 403b with each other. In this example, the spring constant adjusting member 410a, 410b, 410c and 410d are made of acryl resin. However, aluminum or Si may be used alternatively. With regard to the spring constant adjusting member, a lightweight material is preferable.

As shown in FIG. 5B, after the spring constant adjusting members 410a and 410b are mounted, the 402a is being coupled with the springs 403a and 403b. Similarly, the spring 402b is coupled with the springs 403c and 403d. In this example, the resonance frequency of the oscillator device shown in FIG. 5B is about 2800 Hz.

The number of spring-constant adjusting members to be set and the locations to be set are determined in accordance with a desired resonance frequency. For example, if only the spring constant adjustment members 410a and 410d are mounted, the resonance frequency will be about 2500 Hz.

As described above, oscillator devices having largely different resonance frequencies can be manufactured through the same production method. Thus, the manufacturing cost can be reduced significantly. Furthermore, since the spring constant adjusting member can be mounted at any desired position, oscillator devices having various resonance frequencies can be produced.

### Working Example 5

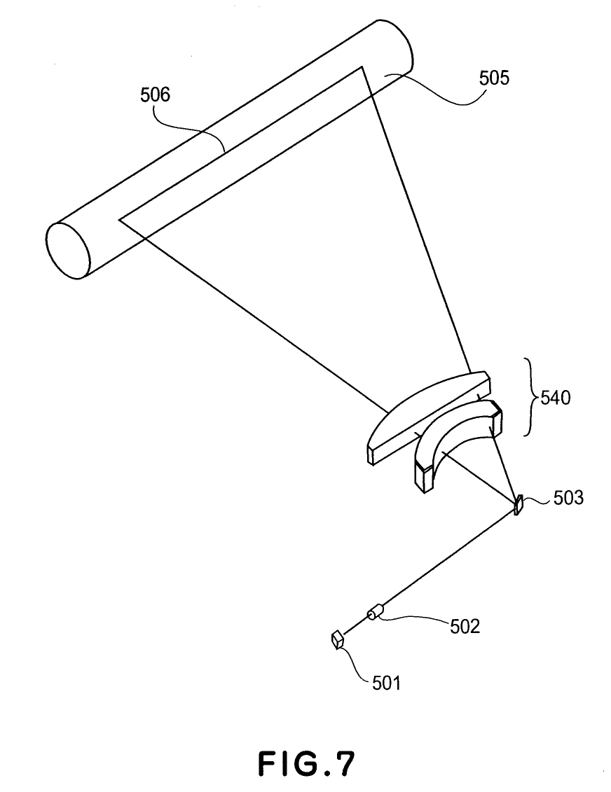

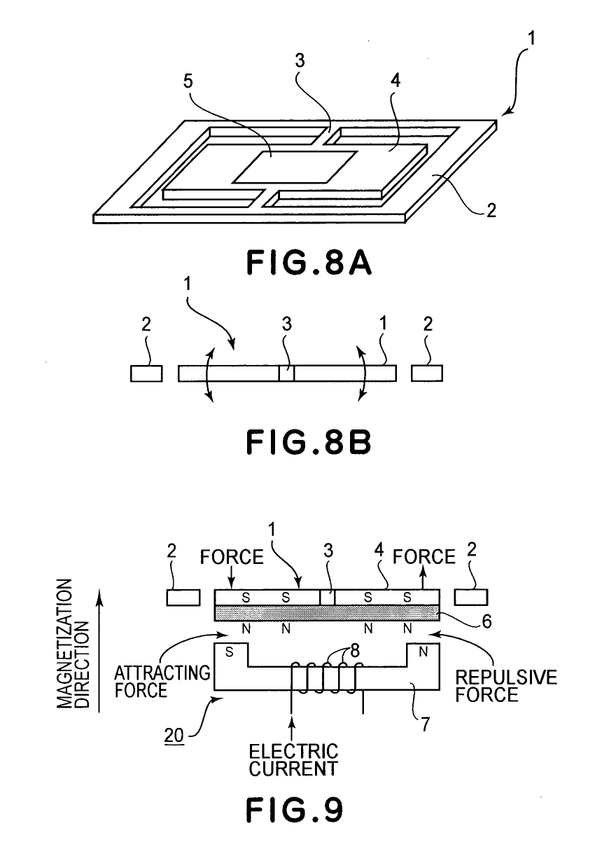

FIG. 7 is a diagram illustrating a working example of an optical equipment using an optical deflector such as described above. Here, an image forming apparatus is shown as the optical equipment. In FIG. 7, denoted at 503 is an oscillator device of the present invention which is used as an optical deflector. In this working example, it is used to scan an incident light one dimensionally.

Denoted at 501 is a light source, and denoted at 502 is a lens or lens group. Denoted at 504 a writing lens or lens group, and denoted at 505 is a photosensitive member. Denoted at 506 is the scan locus.

The light beam emitted from the light source 501 is processed by predetermined intensity modulation in relation to the timing of scanning deflection of the light, and it is scanningly deflected by the optical deflector 503 one dimensionally. This scanned light beam forms an image on the photosensitive member 505 through the writing lens 504. The photosensitive member 505 is electrically charged uniformly by means of a charging device, not shown. By scanning the photosensitive member with light, an electrostatic latent image is formed on that portion. Subsequently, a toner image is formed in the image area of the electrostatic latent image, by means of a developing device, not shown. The toner image is then transferred to a paper sheet (not shown) and fixed thereon, whereby an image is formed on the paper sheet.

Since optical deflectors having largely different resonance frequencies can be manufactured through the same production method, image forming apparatuses having largely different image forming speeds can be manufactured at low cost.

While the invention has been described with reference to the structures disclosed herein, it is not confined to the details set forth and this application is intended to cover such modifications or changes as may come within the purposes of the improvements or the scope of the following claims.

1. An oscillator device, comprising:
a supporting member;
a movable member;
an elastic supporting member configured to elastically support said supporting member and said movable member around an oscillation axis; and
a driving member configured to drive said movable member;
wherein said elastic supporting member includes a plurality of springs and at least one spring constant adjusting member configured to couple the plurality of springs with each other.

2. An oscillator device, comprising:
a supporting member;
a movable member;
an elastic supporting member configured to elastically support said supporting member and said movable member around an oscillation axis; and
a driving member configured to drive said movable member;
wherein said elastic supporting member includes constituent members configured to constitute a meandering structure and at least one spring constant adjusting member configured to couple said constituent members with each other.

3. An oscillator device according to claim 1, wherein said supporting member, said movable member, said elastic supporting member and said spring constant adjusting member are formed integrally from monocrystal silicon.

4. An optical deflector, comprising:
an oscillator device as recited in claim 1; and
an optical deflecting element provided at said movable member of said oscillator device.

5. An image forming apparatus, comprising:
a light source;
an optical deflector as recited in claim 4; and
a photosensitive member;
wherein a light beam from said light source is deflected by said optical deflector to form an electrostatic latent image on said photosensitive member.

6. A method of manufacturing an oscillator device having a supporting member, a movable member, an elastic supporting member configured to elastically support the supporting member and the movable member around an oscillation axis, and a driving member configured to drive the movable member, said method comprising:
a step of forming an elastic supporting member having a plurality of springs and at least one spring constant adjusting member configured to couple the plurality of springs with each other; and
a step of cutting the at least one spring constant adjusting member to change a spring constant.

7. A method of manufacturing an oscillator device having a supporting member, a movable member, an elastic supporting member configured to elastically support the supporting member and the movable member around an oscillation axis, and a driving member configured to drive the movable member, said method comprising:
a step of forming an elastic supporting member having a plurality of constituent members configured to constitute a meandering structure and at least one spring constant adjusting member configured to couple the constituent members with each other; and
a step of cutting the at least one spring constant adjusting member to change a spring constant.

8. A method of manufacturing an oscillator device having a supporting member, a movable member, an elastic supporting member configured to elastically support the supporting member and the movable member around an oscillation axis, and a driving member configured to drive the movable member, said method comprising:
a step of forming an elastic supporting member having a plurality of springs; and
a step of providing at least one spring constant adjusting member configured to couple the plurality of springs with each other, to change a spring constant.

9. A method of manufacturing an oscillator device having a supporting member, a movable member, an elastic supporting member configured to elastically support the supporting member and the movable member around an oscillation axis, and a driving member configured to drive the movable member, said method comprising:
a step of forming an elastic supporting member having a meandering structure; and
a step of providing at least one spring constant adjusting member configured to couple a plurality of constituent members constituting the meandering structure, with each other, to change a spring constant.

10. An oscillator device according to claim 2, wherein said supporting member, said movable member, said elastic supporting member and said spring constant adjusting member are formed integrally from monocrystal silicon.

11. An optical deflector, comprising:
an oscillator device as recited in claim 2; and
an optical deflecting element provided at said movable member of said oscillator device.

12. An image forming apparatus, comprising:
a light source;
an optical deflector as recited in claim 11; and
a photosensitive member;
wherein a light beam from said light source is deflected by said optical deflector to form an electrostatic latent image on said photosensitive member.
